(19) United States
(12) Patent Application Publication
(10) Pub. No.: US 2025/0368888 A1
(43) Pub. Date: Dec. 4, 2025

(54) Relative Permeability Modifiers

(71) Applicant: PETRORAZA SAS, Antioquia (CO)

(72) Inventor: Jose Edgar Patiño, Envigado (CO)

(73) Assignee: PETRORAZA SAS, Antioquia (CO)

(21) Appl. No.: 19/227,092

(22) Filed: Jun. 3, 2025

Related U.S. Application Data
(60) Provisional application No. 63/655,926, filed on Jun. 4, 2024.

(51) Int. Cl. C09K 8/58; B01J 21/04; B01J 23/755; B01J 35/45; B01J 35/61; E21B 43/04; E21B 43/16

(52) U.S. Cl. CPC C09K 8/58; B01J 21/04; B01J 23/755; B01J 35/45; B01J 35/613; E21B 43/04; E21B 43/16

(57) ABSTRACT

Novel relative permeability modifier fluid compositions comprising nickel oxide on alumina nanocatalysts, methods of their manufacture, and methods of their use are disclosed. The novel relative permeability modifier fluid compositions and their methods are useful and extremely desirable, inter alia, to decrease water mobility and/or increase oil mobility in oil-bearing rock formations comprising sandstone and/or limestone, increase levels of oil relative to water in production well effluents, limit downtimes due to treatment of production wells with RPM fluid compositions, improve pumping efficiencies for production well effluents, simplify separations and/or separation efficiencies of oil-water mixtures and/or reduce environmental disposal impacts of separated waters that are extremely desirable.

### FIELD OF THE INVENTION

The present invention relates to relative permeability modifier (“RPM”) compositions useful in the recovery of oil from rock formations where both oil and water are present. Use of the relative permeability modifier compositions may result in increased hydrocarbon permeability and/or decreased water permeability in the oil-containing rock formation in an area proximate to the production well, leading to a higher ratio of oil/water in the fluids removed from the production well. More particularly, this invention relates to hydrocarbon carrier fluid compositions comprising nickel oxide on alumina nanoparticles that may be employed in hydrocarbon production wells. By increasing the level of oil relative to water in fluids removed from the rock formation, production benefits including, for example, improved pumping, extraction and/or separation efficiencies in the oil-water mixtures removed from the oil wells may be provided.

### BACKGROUND OF THE INVENTION

While oil and gas wells are usually completed in hydrocarbon producing zones, a water bearing zone (such as a large expanding aquifer) may occasionally be present adjacent to the hydrocarbon producing zone. The recovery of oil from these formations is complicated by many factors. Viscosity and capillary action tend to keep the oil that remains within the oil-bearing formation from moving toward a production well, thereby reducing the well's oil production. The retentive effects of viscosity may be diminished, for example, by heating the formation to a point where the viscosity of the reservoir fluid becomes equal to or less than the viscosity of the displacing fluid or by increasing the viscosity of the displacing fluid. However, when water or other non-oil-miscible fluid is employed to displace the oil, the retentive forces of capillary action remain unaffected. To remove the retentive effects of capillary action, for example, it is necessary to use a displacing fluid which is miscible with the oil. If the displacing fluid is miscible with the reservoir oil, the interface between the oil and displacing fluid will be removed and, therefore, so will the retentive forces of capillary action.

In some circumstances, the higher mobility of the water may allow it to flow into the hydrocarbon producing zone by way of, inter alia, natural fractures and high permeability streaks, leading to initial water saturation of the rock formation. Undesirable water, including brines, recovered from a well bore can result from the infiltration of naturally occurring subterranean water in this manner.

Another factor complicating the production of this oil is related to this type of water encroachment. Petroleum and other hydrocarbons (hereinafter referred to as “oil” or “hydrocarbon fluids”) in subterranean reservoirs are often driven to production wells by encroaching water from an adjacent zone. When the oil or gas is extracted from these rocks, the encroaching water is co-produced in the well effluent. The amounts of produced water in the effluent rise over the lifetime of production of the well depending upon the proximity and interaction with the water aquifer. A large amount of oil is likely to be left behind in the portion of the reservoir encountered by water.

Normal production methods in the reservoir where water encroachment has taken place will tend to produce large amounts of water along with the oil, leading to lowered efficiency in producing the desired hydrocarbons from the formation. When the ratio of water to hydrocarbons is high in the recovered well effluent, most of the pumping energy is expended in lifting water from the well, adding to production costs. Thereafter the production effluent must be put through expensive separation procedures to recover water-free hydrocarbons. Further adding to overall costs, the separated water constitutes a troublesome and expensive environmental disposal problem. Failure to address these production and related downstream issues may represent a significant economic loss and ultimately shut down a well.

Several possible solutions exist to decrease the well's water/oil mobility ratio. The ratio of water to oil in the well effluent can be expressed in terms of a mobility ratio (M) of displacing fluid to oil within oil-bearing rock formation, where the mobility of each is a function of the permeability (K) of the fluid and the fluid's viscosity.

$$M = ( {K}_{water} / water viscosity ) / ( {K}_{oil} / oil viscosity )$$

First, the mobility of the oil in the formation can be increased relative to the displacing fluid (water), thereby increasing the relative amount of oil in the well effluent. This can be achieved by reducing any retentive effects due to changes in oil viscosity or capillary action (permeability) within the formation. Diminishing the effects due to high viscosity or to low oil permeability should improve the amount of oil relative to water in the well effluent. Alternatively, the mobility of the displacing fluid (water) may be decreased relative to that of the oil to achieve a similar result. That is, the water may be made more viscous in the rock formation or an additive may be used to reduce the water's permeability to the rock. In either case, the efficiency of oil production improves in the gas or oil well. Moreover, when the flow of water into the well bore is decreased, another beneficial effect is obtained in that, at a given pumping rate, there will be a lower liquid level over the pump in the well bore, thus reducing the back pressure in the formation and improving pumping efficiency and net daily oil production. Thirdly, the first two solutions could be combined to provide a method that both decreases water mobility and increases oil mobility in the oil-bearing rock formation.

The production of large amounts of water from oil wells and gas wells can also contribute greatly and adversely to the economics of the overall recovery of hydrocarbons from a subterranean formation. Many oil wells will produce a gross effluent comprising greater than 80% by volume water. In some circumstances, the ratio of water to hydrocarbons recovered may become sufficiently high that the cost of producing, separating, and disposing of the water may represent a significant economic loss.

In 1974, Charles A. Christopher, Jr. et al., (U.S. Pat. No. 3,818,989) disclosed a Method for preferentially producing petroleum from certain reservoirs penetrated by at least one injection well and one production well wherein a fluid of hydrocarbon solvent, colloidal silica, water and a high molecular weight polymer is injected into the injection well and oil is produced from the production well.

Dalrymple and Vinson (U.S. Pat. No. 4,617,132) disclosed a method of reducing the water permeability of hydrocarbon-containing subterranean formations containing sandstone by contacting the formation with an aqueous mixture comprising a water-soluble anionic polymer with molecular weight >100,000 and subsequently contacting the anionic polymer with a polymer stabilizing fluid comprising a water-soluble cationic polymer having a molecular weight >1,000.

U.S. Pat. No. 3,308,885A discloses certain methods for recovering fluid hydrocarbons from a subterranean formation which is penetrated by a well bore, and for reducing the concomitant production of reservoir water therefrom, which comprises injecting into said formation through said well bore an aqueous treating solution comprising a minor proportion of a water-soluble, partially hydrolyzed polyacrylamide treating agent having a molecular weight in excess of about 200,000, at least about 8% but not more than about 70% of the amide groups thereof having been hydrolyzed to carboxyl groups, then terminating the injection of said treating agent and thereafter placing the treated well on production.

U.S. Pat. No. 3,490,533A discloses particular methods for the recovery of oil in a producing formation which comprises injecting into the formation in proximity to a well bore a low viscosity solution of a polymerizable monomer dissolved in water containing a polymerization catalyst having a latent period, permitting the monomer solution to move a distance away from the well bore or adjacent thereto, and after the latent period of the catalyst has expired, permitting the monomer to polymerize to form as a final product a polymer and a relatively high viscosity liquid solution.

U.S. Pat. No. 3,785,437A discloses certain methods for controlling formation permeability by injection into the producing formation of alternating slugs of an aqueous composition containing at least one crosslinkable polymeric material and an aqueous composition containing no crosslinkable polymeric material.

U.S. Pat. No. 3,830,302A discloses particular methods for improving oil-water ratios in oil producing wells that are obtained by treating the formation in the vicinity of the production well with certain combinations of an aqueous, organic polyelectrolyte and a cationic surfactant.

U.S. Pat. No. 3,949,811A discloses certain methods for reducing the permeability of subterranean formations to brines by injecting into the formation's at least one well bore, two slugs of an aqueous polymer solution interspaced with a brine slug.

U.S. Pat. No. 4,579,175A discloses particular methods which reduce water production substantially more than hydrocarbon production in producing wells by the injection of an aqueous solution of alginates.

Almond, et al (EP0136773B1). discloses providing certain compositions for cross-linking carboxyl polymers and the use thereof in treating subterranean formations to modify the formation's permeability to water, wherein the compositions. A composition for crosslinking a water-dispersible, hydrophilic organic polymer having a molecular weight greater than 100,000 and containing a carboxyl functionality, which composition comprises water, a zirconium compound, one or more alpha-hydroxy acids and a secondary or tertiary hydroxyalkylamine.

Nguyen (US20050079981A1) discloses some methods for mitigating the production of water from subterranean formations by injecting consolidation compositions comprising a furan-based resin into an interval in the subterranean formation.

Therefore, new and better relative permeability modifier compositions for use in production wells, preferably within proximity to production well bores, and methods of their use that can decrease water mobility and/or increase oil mobility in oil-bearing rock formations are needed that can increase the level of oil relative to water in well effluents, provide improved pumping efficiencies for well effluents, simplify separation of oil water mixtures and/or their separation efficiencies and/or reduce environmental disposal impacts of separated waters. The present invention is directed to these and other important ends.

### SUMMARY OF THE INVENTION

Accordingly, the present invention is directed, in part, to fluid compositions useful for treating a limestone or sandstone subterranean hydrocarbon-containing formation, the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

In some embodiments, the present invention is directed, in part, to fluid compositions useful for treating a limestone subterranean hydrocarbon-containing formation, the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
   an aliphatic hydrocarbon solvent;
   an aliphatic alcohol; and
   an interfacial tension reducer.

In other embodiments, the present invention is directed, in part, to methods for recovering fluid hydrocarbons from a subterranean limestone or sandstone formation comprising:
contacting the formation and fluid hydrocarbons contained therein, said formation in fluid communication with a production well;
   wherein said contacting of the formation and fluid hydrocarbons contained therein includes contacting with a fluid composition for a time and under conditions sufficient to increase the well's production rate of said fluid hydrocarbons from the formation or to decrease the ratio of water to fluid hydrocarbons in the well's effluent, said the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

In yet other embodiments, In other embodiments, the present invention is directed, in part, to methods for recovering fluid hydrocarbons from a subterranean limestone formation comprising:
contacting the formation and fluid hydrocarbons contained therein, said formation in fluid communication with a production well;
   wherein said contacting of the formation and fluid hydrocarbons contained therein includes contacting with a fluid composition for a time and under conditions sufficient to increase the well's production rate of said fluid hydrocarbons from the formation or to decrease the ratio of water to fluid hydrocarbons in the well's effluent, said the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

The foregoing and other objectives, features, and advantages of the invention will be more readily understood upon consideration of the following detailed description of the invention.

### BRIEF DESCRIPTION OF THE DRAWINGS

FIG. 1 shows the relative permeability curves of a sandstone core sample in Example 2 before and after treatment with an RPM fluid composition of Example 1.

FIG. 2 shows the relative permeability curves of a limestone core sample in Example 3 before and after treatment with an RPM fluid composition of Example 1.

### DETAILED DESCRIPTION OF ILLUSTRATIVE EMBODIMENTS

As employed above and throughout the disclosure of the present invention, the following terms, unless otherwise indicated, shall be understood to have the following meanings.

As used herein, the term “nanoparticle” refers to fine particles having a particle size of less than or equal to 100 nanometers (i.e., less than or equal to 0.1 μm)

As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

As used in the specification and the appended claims, the singular forms “a”, “an,” and “the” include both singular and plural referents unless the context clearly dictates otherwise.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, Band C in combi-nation; or A, B, and C in combination.

Throughout this specification, the term “comprising” or “comprises” means including the component(s) specified but not to the exclusion of the presence of other components.

As used herein, the term “aliphatic hydrocarbon” refers to a non-aromatic organic compound composed solely of carbon and hydrogen, including any optional substituents. Aliphatic hydrocarbons include alkanes, alkenes, alkynes, cycloalkanes, and cycloalkenes. Generally speaking and as used herein, “optional substituents” themselves may not be further substituted.

As used herein, the term “alkyl” or “alkane” each refers to an optionally substituted, saturated straight, or branched, hydrocarbon having from about 1 to about 10 carbon atoms (and all combinations and Subcombinations of ranges and specific numbers of carbon atoms therein), preferably with from about 1 to about 8, more preferably 1 to about 6 carbon atoms. Alkyl groups can be optionally substituted with cycloalkyls or alkylcycloalkyls. Alkyl groups include, but are not limited to, methyl, ethyl, n-propyl, isopropyl. n-butyl, isobutyl, t-butyl, n-pentyl, isopentyl, neopentyl, n-hexyl, iso hexyl, 3-methylpentyl, 2,2-dimethylbutyl, and 2,3-dimethylbutyl.

As used herein, the term “alkenyl or “alkene” each refers to an optionally substituted alkyl group having from about 2 to about 10 carbon atoms and one or more double bonds (and all combinations and Subcombinations of ranges and specific numbers of carbon atoms therein), wherein alkyl is as previously defined.

As used herein, the term “alkynyl” or “alkyne” each refers to an optionally substituted alkyl group having from about 2 to about 10 carbon atoms and one or more triple bonds (and all combinations and Subcombinations of ranges and specific numbers of carbon atoms therein), wherein alkyl is as previously defined.

As used herein, the term “cycloalkyl or “cycloalkene” each refers to an optionally Substituted, mono-, di-, tri-, or other multicyclic alicyclic ring system having from about 3 to about 20 carbon atoms (and all combinations and Subcom binations of ranges and specific numbers of carbon atoms therein). In some preferred embodiments, the cycloalkyl groups have from about 3 to about 8 carbon atoms. Multi ring structures may be bridged or fused ring structures, wherein the additional groups fused or bridged to the cycloalkyl ring may include optionally substituted cycloalkyl. Exemplary cycloalkyl groups include, but are not limited to, cyclopropyl, cyclobutyl, cyclopentyl, cyclohexyl, cyclooctyl, adamantyl, and 2-1.2.3,4-tetrahydro-naphthalenyl.

As used herein, the term “cycloalkylalkyl refers to an optionally substituted ring system composed of an alkyl radical having one or more cycloalkyl substituents wherein alkyl and cycloalkyl are as previously defined. In some preferred embodiments, the alkyl moieties of the cycloalkylalkyl groups have from about 1 to about 3 carbon atoms. Exemplary cycloalkylalkyl groups include, but are not limited to, cyclohexylmethyl, 4-4-methyldecahydronaphthalenyl-pentyl, 3-trans 2,3-dimethylcyclooctyl-propyl, and cyclopentylethyl.

As used herein, the term “aliphatic alcohol” refers to an aliphatic hydrocarbon as defined herein wherein one hydrogen on the aliphatic hydrocarbon is substituted with a hydroxyl (—OH) group. Exemplary aliphatic alcohols include, but are not limited to n-propyl alcohol, isopentyl alcohol, 2-ethyl-hexanol, cycloheaxanol, and cyclohexylmethanol.

As used herein, an interfacial tension reducer refers to a surface-active compound that reduces interfacial tension (IFT) of a fluid-fluid (water-oil) interface. As used herein, “interfacial tension” refers to the force acting along the interface separating water and oil (or other aliphatic hydrocarbon fluids). Exemplary interfacial tension reducers include, but are not limited to, surfactants, preferably nonionic or anionic surfactants. Exemplary surfactants include but are limited to the sodium salts of high molecular weight alkyl sulfates or sulfonates. Most hydrocarbon solvents are normally thickened by the use of anionic surfactants such as, for example, sodium linear alkyl sulfonates. In some embodiments, a surfactant is added to improve the stability of the emulsion and to reduce the surface tension holding the oil to mineral surfaces.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

When ranges are used herein for physical properties, such as molecular weight, particle size, or chemical properties, such as chemical formulae, contacting times of reagents, pressures, temperatures, and drying times, all combinations and subcombinations of ranges and specific embodiments therein are intended to be included.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

The disclosures of each patent, patent application and publication cited or described in this document are hereby incorporated herein by reference, in their entirety.

Benefits of the fluid compositions include but are not limited to one or more of the following: decreased water mobility and/or increased oil mobility in oil-bearing rock formations comprising sandstone and/or limestone, increased levels of oil relative to water in production well effluents, limited downtimes for treatment of production wells with RPM fluid compositions, improved pumping efficiencies for production well effluents, simplified separations and/or separation efficiencies of oil-water mixtures and/or reduced environmental disposal impacts of separated waters.

This invention is directed to, inter alia, the surprising and unexpected discovery of a new class of relative permeability modifier fluid compositions containing nanocatalysts, aliphatic hydrocarbon solvents, aliphatic alcohols and interfacial tension reducer compounds and/or compositions.

This invention is further directed to, inter alia, processes for their preparation of relative permeability modifier fluid compositions containing nanocatalysts, aliphatic hydrocarbon solvents, aliphatic alcohols and interfacial tension reducer compounds and/or compositions, and methods of their use.

Accordingly, in certain embodiments, the present invention provides fluid compositions useful for treating a limestone or sandstone subterranean hydrocarbon-containing formation, the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 80 to about 500, preferably in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
   an aliphatic hydrocarbon solvent;
   an aliphatic alcohol; and
   an interfacial tension reducer.

In yet other embodiments, the present invention provides fluid compositions useful for treating a limestone or sandstone subterranean hydrocarbon-containing formation, the fluid composition consisting essentially of:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 80 to about 500, preferably in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
   an aliphatic hydrocarbon solvent;
   an aliphatic alcohol; and
   an interfacial tension reducer.

In yet other embodiments, the present invention provides fluid compositions useful for treating a limestone or sandstone subterranean hydrocarbon-containing formation, the fluid composition consisting of:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 80 to about 500, preferably in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
   an aliphatic hydrocarbon solvent;
   an aliphatic alcohol; and
   an interfacial tension reducer.

In certain other embodiments, the present invention provides fluid compositions useful for treating a limestone subterranean hydrocarbon-containing formation, the fluid composition comprising, consisting essentially or consisting of:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 80 to about 500, preferably in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
   an aliphatic hydrocarbon solvent;
   an aliphatic alcohol; and
   an interfacial tension reducer.

In certain preferred embodiments of the fluid compositions according to the invention, the nanocatalyst comprises a nanocatalyst as disclosed in U.S. Pat. No. 9,339,796, the disclosure of which is hereby incorporated herein by reference, in its entirety. In other preferred embodiments, the above noted nanocatalyst is a nickel oxide on alumina nanocatalyst as disclosed therein.

As one of ordinary skill in the art would appreciate, a wide range of aliphatic hydrocarbon solvents, aliphatic alcohols and/or interfacial tension reducer compounds and/or compositions are useful in the fluid compositions of the invention. Compounds having similar, though not necessarily identical physical and/or chemical properties are herein contemplated within the scope and use of the invention. Generally speaking, any aliphatic hydrocarbon solvent should, preferably must be miscible with the hydrocarbon fluids (e.g., oil) contained in the subterranean sandstone or limestone formation. For example, the aliphatic hydrocarbon solvent, Exxsol™D40, which is satisfactory for purposes of the compositions and methods of the present invention, is a blend of a range of aliphatic compounds. Thus, any single or multi-component aliphatic solvents with similar properties to Exxsol™D40 would also likely be satisfactory. Likewise, aliphatic alcohols, as the term is herein defined, would generally be useful in the compositions and methods of the present invention. One such example would be 2-ethyl-hexanol.

In certain preferred embodiments, the herein described fluid compositions further comprise a buffer, preferably a carboxylic acid buffer, more preferably an aliphatic carboxylic acid buffer. In other preferred embodiments, the carboxylic acid is an alkyl carboxylic acid, more preferably an optionally substituted acetic, propanoic, butanoic, pentanoic or hexanoic acid, more preferably, an acetic acid buffer. In some preferred embodiments where fluid compositions contact limestone formations, buffers may be relatively more advantageous.

In other preferred embodiments, the fluid compositions further comprise a silica component, preferably an amorphous fumed silica component. The fumed silica is made up of chain-like formations sintered together. These chains are branched and have enormous external surface areas of from about 50 to about 400 meters²/gram. When the silica particles are dispersed in a liquid medium, the network structure formed by the silica particles may restrict the movement of the molecules of the liquid medium. This in turn may result in an increase in the viscosity of the liquid. Fumed silicas are readily available commercially. One source of fumed hydrophilic pyrogenic silica is the Wacker Chemie AG of Munich, Germany . . . . Famed silica is also available from other commercial sources and the reference to one source is not intended to limit the scope of our invention. In some preferred embodiments where fluid compositions contact limestone formations, a silica component is advantageous, preferably to reduce water permeability in the formation. In certain other preferred embodiments a buffer and a silica may be employed together in the herein described fluid compositions.

In other embodiments, up to about 10%, 20%, 30%, 40% or even up to about 50% by weight of water may be optionally added to the fluid compositions, particularly when used to treat sandstone conformations due to the formation's increased permeability. While the amount of optionally added water present in fluid compositions for use in sandstone or limestone formations is not critical, in some preferred embodiments, reducing water levels in fluid compositions for use in limestone formations is relatively more important than in sandstone formations. Accordingly, in certain embodiments, less than about 10%, preferably less than about 5%, more preferably less than about 1%, and even more preferably less than a de minimus amount of water is present in the fluid compositions.

In other embodiments of the present invention, the fluid compositions do not comprise organic polymers, particularly any disclosed as useful in driving fluids for use in wells having both injection and production well bores. Exemplary organic polymers typically excluded from the fluid compositions include but are not limited to polyacrylamides, polysaccharides, water soluble starch derivatives containing carboxyl sulfonate or sulfate groups in the form of sodium or ammonium salts, soluble cellulose derivatives, polyvinyl alcohol, polyvinyl pyrrolidone, poly (arylic acid), poly (ethylene oxide) and polyethyleneimines.

In some embodiments, the invention is directed to processes for preparing a relative permeability modifier fluid composition comprising: a nanocatalyst, said nanocatalyst comprising nickel oxide nanoparticles supported on alumina nanoparticles;
wherein the alumina nanoparticle to nickel oxide nanoparticle weight to weight ratio in the catalyst is in a range of from about 99 to about 400;
wherein the particle size of the alumina nanoparticle is in a range of from about 30 to about 100 nanometers;
wherein the catalyst does not further comprise silver nanoparticles supported on the alumina nanoparticles; and
wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer;
said process comprising mixing an aliphatic hydrocarbon solvent, an aliphatic alcohol; and an interfacial tension reducer for a time and under conditions sufficient to prepare a carrier fluid mixture;
adding said nanocatalyst comprising nickel oxide nanoparticles supported on alumina nanoparticles to the carrier fluid, preferably a nanocatalyst as disclosed in U.S. Pat. No. 9,339,796; and sonicating the nanocatalyst-containing carrier fluid for a time and under conditions sufficient to provide the relative permeability modifier fluid composition. In other embodiments, the fluid composition is a product of the above disclosed process.

In certain embodiments, the invention is directed to methods for producing hydrocarbons from limestone and/or sandstone subterranean formations. In one aspect this invention relates to methods for reducing the permeability and porosity of subterranean formations to water thereby decreasing relative mobility ratio of water to oil in the formation. In another embodiment, this invention relates to methods for reducing the quantity of water recovered from a subterranean formation penetrated by a production well bore and/or for increasing the production rate of fluid hydrocarbons from the production well bore. Accordingly, the invention also relates to the production of the well when the well is placed back on production after treatment with certain of the herein described RPM fluid compositions under the same conditions as prior to such treatment. Under the same conditions before and after treatment, the production wells may provide for a substantial reduction in the water/oil ratio of the well effluent due to an increased hydrocarbon fluid rate and/or a reduced flow rate of water into the well bore. Moreover, as a result of this decreased water flow rate per unit of hydrocarbon recovered, there will be, at the same gross production rate, a reduction in fluid level over the pump, with resultant decrease in back pressure on the formation, thus permitting oil to move more rapidly out of the formation into the well bore. Thus, although the immediate effect of the treating process of this invention is to decrease the rate of flow of water into the well bore, a secondary effect of increasing the absolute daily production rate of oil is also obtainable.

In other embodiments, the invention is directed to methods for recovering fluid hydrocarbons from a subterranean limestone or sandstone formation comprising:
contacting the formation and fluid hydrocarbons contained therein, said formation in fluid communication with a production well;
wherein said contacting of the formation and fluid hydrocarbons contained therein includes contacting with a fluid composition as described herein for a time and under conditions sufficient to increase the well's production rate of said fluid hydrocarbons from the formation or to decrease the ratio of water to fluid hydrocarbons in the well's effluent. In certain aspects, the methods relate to recovering fluid hydrocarbons from a subterranean limestone formations. In other aspects, the invention relates to methods for recovering fluid hydrocarbons from a subterranean sandstone formation. In other aspects, the methods exclude their utilization in wells having both injection and producing legs in contact with the subterranean formation.

In certain other embodiments, the methods relate to a contacting with the RPM fluid composition whereby its introduction into the well that does exceed the intrinsic fracture pressure of the formation. In still other embodiments, subsequent to said contacting, the well is maintained in a static condition for a period of time, preferably from about 4 hours to about 36 hours, more preferably from about 8 to about 12 hours, before fluid hydrocarbon removal is initiated. In yet other embodiments, after the static condition period, the fluid hydrocarbons may be, and preferably are, extracted from the formation.

In still other embodiments, wherein the formation and fluid hydrocarbons contained therein, said formation in fluid communication with a production well, have been previously treated by contacting with a with a fluid composition as described herein for a time and under conditions sufficient to increase the well's production rate of said fluid hydrocarbons from the formation or to decrease the ratio of water to fluid hydrocarbons in the well's effluent, the formation and fluid hydrocarbons contained therein, said formation in fluid communication with a production well, may be subsequently retreated by contacting with a retreatment fluid composition for a time and under intrinsic well temperature conditions sufficient to increase the well's production rate of said fluid hydrocarbons from the formation or to decrease the ratio of water to fluid hydrocarbons in the well's effluent; said retreatment fluid composition comprising:
a nanocatalyst, said nanocatalyst comprising:
   nickel oxide nanoparticles supported on alumina nanoparticles;
   wherein:
      the alumina nanoparticle to nickel oxide nanoparticle weight to weight ratio in the catalyst is in a range of from about 99 to about 400;
      the particle size of the alumina nanoparticle is in the range of from about 30 to about 100 nanometers;
      the catalyst does not further comprise silver nanoparticles supported on the alumina nanoparticles;
      the alumina nanoparticles are present in an amount of at least 99% by weight of catalyst; and
      the S_{BET} surface area is from about 17 to about 70 m²/g;
an aliphatic hydrocarbon solvent;
an aliphatic alcohol; and
an interfacial tension reducer.

The time between any initial well RPM fluid composition treatment method and any subsequent retreatment may vary dependent on the particular well, effluent composition or conditions or costs associated with a well's production or any of the other parameters herein mentioned. Typically, this may be related to water levels returning to higher levels that render operation of the well and/or isolation of the product hydrocarbon fluids cost ineffective. Retreatments at future times may be continued until the costs associated with use of the RPM fluid compositions and well downtime exceed any gains in hydrocarbon fluid productivity.

Once armed with the disclosures provided herein, the skilled artisan will be able to appreciate and employ to great advantage for use in production wells the relative permeability modifier fluid compositions methods, techniques and processes disclosed herein that may decrease water mobility and/or increase oil mobility in oil-bearing rock formations comprising sandstone and/or limestone, increase levels of oil relative to water in production well effluents, limited downtimes due to treatment of production wells with RPM fluid compositions, improve pumping efficiencies for production well effluents, simplify separations and/or separation efficiencies of oil-water mixtures and/or reduce environmental disposal impacts of separated waters that are extremely desirable.

The present invention is further described in the following examples. Except where specifically noted, the examples are actual examples. These examples are for illustrative purposes only, and are not to be construed as limiting the appended claims.

### EXPERIMENTAL SECTION

### Examples of the Present Invention

### Example 1: Preparation of Relative Permeability Modifier (RPM) Fluid Composition

A carrier fluid for RPM was prepared by blending 70% w/w of an aliphatic hydrocarbon solvent (Exxsol™D40) sourced from Brenntag and 25% w/w of 2-ethyl hexanol sourced from Carboquimica-Colombia with 5% w/w of a WP004X™ interfacial tension reducer sourced from Petroraza. The blend was then stirred at 25° C. for 2 hours to homogenize the mixture. A nanocatalyst¹ (1000 mg/liter of carrier fluid) was poured into the carrier fluid and stirred for 3 hours. The resultant fluid was directly sonicated for two hours using a long probe (QSonica Model Q1375, transmitting 600000 Joules of energy at a frequency of 20 KHZ, sonicating the sample for 2 hours prepare a stable suspension of the RPM fluid composition. ¹ A nickel oxide nanoparticle (a mean size of 95 nm) supported on alumina nanocatalyst comprising 1% by weight nickel oxide nanoparticles and 99% by weight of alumina nanoparticles (sourced from Petroraza SAS).

### Example 2

The relative water/oil permeability of a sandstone core was tested following the Method of API RP40 (Recommended Practice for Core-Analysis Procedure (American Petroleum Institute, 1960)). The porous media utilized was a sandstone core sourced from Petrorocas having a porosity of 10.5%, diameter of 3.77 cm and length of 6.93 cm., total porous volume of the core was 8.11 cc.

The injection fluids used to determine relative water/oil permeability included a one liter sample of Heavy oil sourced from Hocol S.A, a one liter sample of synthetic brine prepared with deionized water and Sodium chloride (220 g, sourced from Sigma Aldrich), and the Relative Permeability modifier fluid composition (100 cc) obtained in Example 1.

The equipment employed in the testing procedure included a commercial pump (Cole-Parmer Instrument Co., Canada), a positive displacement pump (DB Robinson Group, Canada), fraction collectors and a stainless steel core holder. An oven from Terrigeno was used to perform the testing at 45° C., pore pressure of 240 psi. To maintain reservoir conditions, the overburden pressure was kept at 717 psi. the testing steps employed follow:

Synthetic brine was injected (81.1 cc (10 pv)) at a constant rate of 0.7 cc/min. The change (delta) in pressure was monitored. Heavy oil was injected (81.1 cc (10 pv)) at a constant rate of 0.7 cc/min. The change (delta) in pressure was monitored. The effective permeability of the oil was measured to establish initial conditions. Synthetic brine was injected (81.1 cc (10 pv)) at a constant rate of 0.7 cc/min. The change (delta) in pressure was monitored. The effective permeability of the brine was measured to establish initial conditions and construct relative permeability curves. The RPM fluid composition of Example 1 was injected (16.22 cc (2 pv)) at a constant rate of 0.7 cc/min. The sample was maintained at testing conditions for eight hours. Then, an additional amount of heavy oil was injected (81.1 cc (10 pv)) at a constant rate of 0.7 cc/min, followed by a pressure measurement and determination of effective oil permeability for the sample. An additional amount of synthetic brine was injected (81.1 cc (10 pv)) at a constant rate of 0.7 cc/min. The change in pressure and effective water permeability were determined and the relative permeability curves after RPM were constructed.

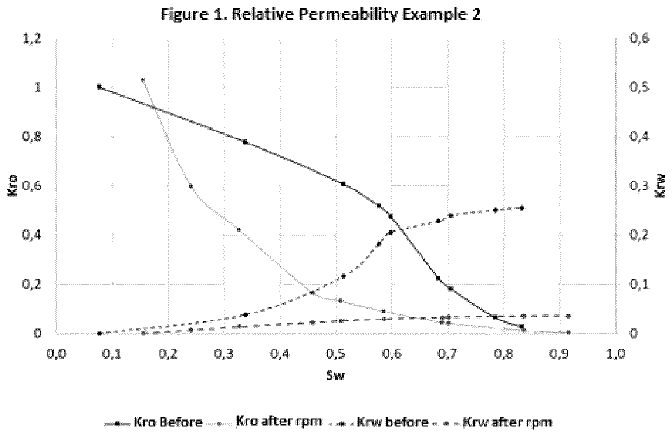

The oil permeability was increased up to from 726 millidarcy to 747 millidarcy and while the water permeability was reduced from 387 millidarcy to 85 millidarcy after the RPM fluid composition was injected into the porous media sample. FIG. 1 shows the relative permeability curves for Example 2 before and after RPM.

### Example 3

The relative water/oil permeability of a sandstone core was tested following the Method of API RP40 (Recommended Practice for Core-Analysis Procedure (American Petroleum Institute, 1960)). The porous media utilized was a limestone core sourced from Petrorocas having a porosity of 10.19%, diameter of 3.77 cm and length of 5.01 cm., total porous volume of the core was 5.70 cc.

The injection fluids used to determine relative water/oil permeability included a one liter sample of light oil sourced from Parex Resources, a one liter sample of synthetic brine prepared with deionized water and Sodium chloride (75 g, sourced from Sigma Aldrich), and the Relative Permeability modifier fluid composition (100 cc) obtained in Example 1 and additionally buffered with 0.2 cc of acetic acid. Amorphous Fumed Silica (0.1 grams, Wacker) was added to the buffered RPM fluid composition and the mixture was stirred and homogenized for 30 minutes.

The equipment employed in the testing procedure included a commercial pump (Cole-Parmer Instrument Co., Canada), a positive displacement pump (DB Robinson Group, Canada), fraction collectors and a stainless steel core holder. An oven from Terrigeno was used to perform the testing at 85° C., pore pressure of 1500 psi. To maintain reservoir conditions, the overburden pressure was kept at 2000 psi. the testing steps employed follow:

Synthetic brine was injected (57 cc (10 pv)) at a constant rate of 0.1 cc/min. The change (delta) in pressure was monitored. Light oil was injected (57 cc (10 pv)) at a constant rate of 0.1 cc/min. The change (delta) in pressure was monitored. The effective permeability of the oil was measured to establish initial conditions. Synthetic brine was injected (57 cc (10 pv)) at a constant rate of 0.1 cc/min. The change (delta) in pressure was monitored. The effective permeability of the brine was measured to establish initial conditions and construct relative permeability curves. The buffered RPM fluid composition of Example 3 containing amorphous fumed silica was injected (11.4 cc (2 pv)) at a constant rate of 0.1 cc/min. The sample was maintained at testing conditions for twelve hours. Then, an additional amount of light oil was injected (57 cc (10 pv)) at a constant rate of 0.1 cc/min, followed by a pressure measurement and determination of effective oil permeability for the sample. An additional amount of synthetic brine was injected (57 cc (10 pv)) at a constant rate of 0.1 cc/min. The change in pressure and effective water permeability were determined and the relative permeability curves after RPM were constructed.

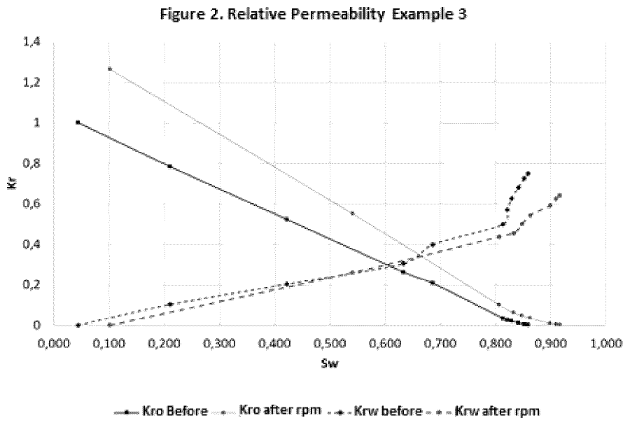

The oil permeability was increased up to from 15 millidarcy to 19 millidarcy and while the water permeability was maintained at 10 millidarcy after the RPM fluid composition was injected into the porous media sample. FIG. 2 shows the relative permeability curves for Example 3 before and after RPM.

### Example 4

Oil Well Bon-1 was producing oil and water from a cretaceous sandstone underground formation (porosity of 0.27 and a permeability of 4 Darcy). The depth of the underground formation was 1706 m. The producing interval opening of the underground formation capable of producing oil was 10 meters thick. The formation had an initial water Saturation of 25%. After 17 months of continuous production, the water content of effluent increased to an extent that the effluent from the well contained 91% of water and 9% oil. The volume of RPM fluid composition² needed to establish an injected cylindrical zone in a 7 foot proximity to the well bore was calculated³. The RPM fluid composition was injected at a pumping pressure below the fracturing pressure of the rock into the underground oil-bearing formation around the well with a calculated penetration of 7 feet into the surrounding zone of the well bore. Then 24 hours of soaking time was allowed. After the soaking time period, the well was opened for production. The levels of water and oil in the well effluent were measured (48% water, 52% oil), confirming the modification of the relative oil and water permeabilities. After 10 months in production, the levels of water and oil in the well effluent were again measured (83% water, 17% oil), indicating that the well was still producing a lower water/oil ratio-containing effluent than before the initial RPM fluid composition treatment. ² The RPM fluid composition injected contained 1000 milligrams of the Nanocatalyst Nickel oxide Nanoparticles supported an alumina Nanoparticles per liter of the carrier fluid and was prepared in analogous fashion to that obtained in Example 1.³ Volume of RPM=Volume of cylinder in a 7 ft around the wellbore within Producer Pay zone multiplied for the fraction of Porosity of the formation.

Embodiment 1. A fluid composition for treating a limestone or sandstone subterranean hydrocarbon-containing formation, the fluid composition comprising:
a nanocatalyst, said nanocatalyst comprising nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in a range of from about 30 to about 100 nanometers;
   wherein the catalyst does not further comprise silver nanoparticles supported on the alumina nanoparticles; and
   wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

Embodiment 2. A fluid composition for treating a limestone or sandstone subterranean hydrocarbon-containing formation according to Embodiment 1, the fluid composition consisting essentially of:
a nanocatalyst, said nanocatalyst comprising: nickel oxide nanoparticles supported on alumina nanoparticles;
   wherein the alumina nanoparticle to nickel oxide nanoparticle weight to weight ratio in the catalyst is in a range of from about 99 to about 400;
   wherein the particle size of the alumina nanoparticle is in the range of from about 30 to about 100 nanometers;
   wherein the catalyst does not further comprise silver nanoparticles supported on the alumina nanoparticles; and
   wherein the alumina nanoparticles are present in an amount of at least 99% by weight of catalyst; or the S_{BET} surface area is from about 17 to about 70 m²/g;
an aliphatic hydrocarbon solvent;
an aliphatic alcohol; and
an interfacial tension reducer.

Embodiment 3. A fluid composition for treating a limestone or sandstone subterranean hydrocarbon-containing formation according to Embodiment 1, the fluid composition consisting of:
a nanocatalyst, said nanocatalyst comprising nickel oxide nanoparticles supported on alumina nanoparticles;
wherein the alumina nanoparticle to nickel oxide nanoparticle weight to weight ratio in the catalyst is in a range of from about 99 to about 400;
wherein the particle size of the alumina nanoparticle is in the range of from about 30 to about 100 nanometers;
wherein the catalyst does not further comprise silver nanoparticles supported on the alumina nanoparticles; and
wherein the alumina nanoparticles are present in an amount of at least 99% by weight of catalyst or the S_{BET} surface area is from about 17 to about 70 m²/g;
   an aliphatic hydrocarbon solvent;
   an aliphatic alcohol; and
   an interfacial tension reducer.

Embodiment 4. A fluid composition according to Embodiment 1, 2 or 3 for treating a limestone subterranean hydrocarbon-containing formation.

Embodiment 5. A fluid composition according to Embodiment 1, 2 or 3 for treating a sandstone subterranean hydrocarbon-containing formation.

Embodiment 6. A fluid composition according to Embodiment 1, 2, 3, 4 or 5 further comprising a carboxylic acid buffer.

Embodiment 7. A fluid composition according to Embodiment 6, wherein the carboxylic acid buffer is acetic acid.

Embodiment 8. A fluid composition according to claim 1, 2, 3, 4, 5, 6 or 7 further comprising silica.

Embodiment 9. A method for recovering fluid hydrocarbons from a subterranean limestone or sandstone formation comprising:
contacting the formation and fluid hydrocarbons contained therein, said formation in fluid communication with a production well;
   wherein said contacting of the formation and fluid hydrocarbons contained therein includes contacting with a fluid composition of Embodiment 1, 2, 3, 4, 5, 6, 7 or 8 for a time and under conditions sufficient to increase the well's production rate of said fluid hydrocarbons from the formation or to decrease the ratio of water to fluid hydrocarbons in the well's effluent.

Embodiment 10. A method for retreating a production well previously treated by the method according to Embodiment 1, 2, 3, 4, 5, 6, 7 or 8 with a fluid composition comprising a nickel oxide nanocatalyst on alumina, an aliphatic hydrocarbon solvent, an aliphatic alcohol and an interfacial tension reducer, wherein the formation and fluid hydrocarbons contained therein are retreated by contacting with a retreatment fluid composition for a time and under intrinsic well temperature conditions sufficient to increase the well's production rate of said fluid hydrocarbons from the formation or to decrease the ratio of water to fluid hydrocarbons in the well's effluent; said retreatment fluid composition comprising a nanocatalyst, said nanocatalyst comprising nickel oxide nanoparticles supported on alumina nanoparticles;
wherein the alumina nanoparticle to nickel oxide nanoparticle weight to weight ratio in the catalyst is in a range of from about 99 to about 400;
wherein the particle size of the alumina nanoparticle is in the range of from about 30 to about 100 nanometers;
wherein the catalyst does not further comprise silver nanoparticles supported on the alumina nanoparticles; and
wherein the alumina nanoparticles are present in an amount of at least 99% by weight of catalyst; or the S_{BET} surface area is from about 17 to about 70 m²/g;
an aliphatic hydrocarbon solvent;
an aliphatic alcohol; and
an interfacial tension reducer.

Embodiment 11. A method according to Embodiment 9 or 10, wherein the contacting does not exceed the intrinsic fracture pressure of the formation.

Embodiment 12. A method according to Embodiment 9, 10 or 11 wherein, subsequent to said contacting, the well is maintained in a static condition for a period of time before fluid hydrocarbon removal is initiated.

Embodiment 13. A method according to Embodiment 12, wherein the static condition period of time is from about 4 hours to about 36 hours.

Embodiment 14. A method according to claim 13, wherein the static condition period of time is from about 8 hours to about 12 hours.

Embodiment 15. A method according to Embodiment 12, 13 or 14 wherein, after the static condition period, the fluid hydrocarbons are extracted from the formation.

Embodiment 16. A method according to Embodiment 9, 10, 11, 12, 13, 14 or 15 wherein the fluid composition further comprises a carboxylic acid buffer.

Embodiment 17. A method according to Embodiment 16, wherein the carboxylic acid buffer is acetic acid.

Embodiment 18. A method according to Embodiment 9, 10, 11, 12, 13, 14, 15, 16 or 17 wherein the fluid composition further comprises silica.

When any variable occurs more than one time in any constituent or in any formula, its definition in each occurrence is independent of its definition at every other occurrence. Combinations of substituents and/or variables are permissible only if such combinations result in stable compositions.

It is believed the chemical formulas, abbreviations, and names used herein correctly and accurately reflect the underlying compounds reagents and/or moieties. However, the nature and value of the present invention does not depend upon the theoretical correctness of these formulae, in whole or in part. Thus it is understood that the formulas used herein, as well as the chemical names and/or abbreviations attributed to the correspondingly indicated compounds, are not intended to limit the invention in any way, including restricting it to any specific form or to any specific isomer.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A fluid composition for treating a limestone or sandstone subterranean hydrocarbon-containing formation, the fluid composition comprising:
a nanocatalyst, said nanocatalyst comprising nickel oxide nanoparticles supported on alumina nanoparticles;
wherein the alumina nanoparticle to nickel oxide nanoparticle weight to weight ratio in the catalyst is in a range of from about 99 to about 400;
wherein the particle size of the alumina nanoparticle is in a range of from about 30 to about 100 nanometers;
wherein the catalyst does not further comprise silver nanoparticles supported on the alumina nanoparticles; and
wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

2. A fluid composition according to claim 1 further comprising a carboxylic acid buffer.

3. A fluid composition according to claim 2 further wherein the carboxylic acid buffer is acetic acid.

4. A fluid composition according to claim 1 further comprising silica.

5. A fluid composition according to claim 2 further comprising silica.

6. A method for recovering fluid hydrocarbons from a subterranean limestone or sandstone formation comprising:
contacting the formation and fluid hydrocarbons contained therein, said formation in fluid communication with a production well;
wherein said contacting of the formation and fluid hydrocarbons contained therein includes contacting with a fluid composition of claim 1 for a time and under conditions sufficient to increase the well's production rate of said fluid hydrocarbons from the formation or to decrease the ratio of water to fluid hydrocarbons in the well's effluent.

7. A method according to claim 6, wherein the contacting does not exceed the intrinsic fracture pressure of the formation.

8. A method according to claim 6, wherein, subsequent to said contacting, the well is maintained in a static condition for a period of time before fluid hydrocarbon removal is initiated.

9. A method according to claim 6, wherein the formation and fluid hydrocarbons contained therein are subsequently retreated by recontacting with a retreatment fluid composition for a time and under intrinsic well temperature conditions sufficient to increase the well's production rate of said fluid hydrocarbons from the formation or to decrease the ratio of water to fluid hydrocarbons in the well's effluent; said retreatment fluid composition comprising:
a nanocatalyst, said nanocatalyst comprising:
nickel oxide nanoparticles supported on alumina nanoparticles;
wherein:
the alumina nanoparticle to nickel oxide nanoparticle weight to weight ratio in the catalyst is in a range of from about 99 to about 400;
the particle size of the alumina nanoparticle is in the range of from about 30 to about 100 nanometers;
the catalyst does not further comprise silver nanoparticles supported on the alumina nanoparticles;
the alumina nanoparticles are present in an amount of at least 99% by weight of catalyst; or
the S_{BET} surface area is from about 17 to about 70 m²/g;
an aliphatic hydrocarbon solvent;
an aliphatic alcohol; and
an interfacial tension reducer.

10. A method according to claim 9, wherein the retreatment fluid composition further comprises a carboxylic acid buffer.

11. A method according to claim 10 further wherein the retreatment fluid composition's carboxylic acid buffer is acetic acid.

12. A method according to claim 9, wherein the retreatment fluid composition further comprises silica.

13. A method according to claim 10, wherein the retreatment fluid composition further comprises silica.

14. A method according to claim 8, wherein the static condition period of time is from about 4 hours to about 36 hours.

15. A method according to claim 14, wherein the static condition period of time is from about 8 hours to about 12 hours.

16. A method according to claim 8, wherein, after the static condition period, the fluid hydrocarbons are extracted from the formation.

17. A method according to claim 9, wherein the recontacting does not exceed the intrinsic fracture pressure of the formation.

18. A method according to claim 9, wherein, subsequent to said recontacting, the well is maintained in a static condition for an additional period of time before fluid hydrocarbon removal is reinitiated.

19. A method according to claim 18, wherein the additional static condition period of time is from about 4 hours to about 36 hours.

20. A method according to claim 19, wherein the additional static condition period of time is from about 8 hours to about 12 hours.

21. A method according to claim 18, wherein, after the additional static condition period of time, extraction of the fluid hydrocarbons from the formation is reinitiated.

22. A fluid composition for treating a limestone or sandstone subterranean hydrocarbon-containing formation according to claim 1, the fluid composition consisting essentially of:
a nanocatalyst, said nanocatalyst comprising:
nickel oxide nanoparticles supported on alumina nanoparticles;
wherein:
the alumina nanoparticle to nickel oxide nanoparticle weight to weight ratio in the catalyst is in a range of from about 99 to about 400;
the particle size of the alumina nanoparticle is in the range of from about 30 to about 100 nanometers;
the catalyst does not further comprise silver nanoparticles supported on the alumina nanoparticles;
the alumina nanoparticles are present in an amount of at least 99% by weight of catalyst; and
the S_{BET} surface area is from about 17 to about 70 m²/g;
an aliphatic hydrocarbon solvent;
an aliphatic alcohol; and
an interfacial tension reducer.

23. A fluid composition for treating a limestone or sandstone subterranean hydrocarbon-containing formation according to claim 1, the fluid composition consisting of:
a nanocatalyst, said nanocatalyst comprising:
nickel oxide nanoparticles supported on alumina nanoparticles;
wherein:
the alumina nanoparticle to nickel oxide nanoparticle weight to weight ratio in the catalyst is in a range of from about 99 to about 400;
the particle size of the alumina nanoparticle is in the range of from about 30 to about 100 nanometers;
the catalyst does not further comprise silver nanoparticles supported on the alumina nanoparticles;
the alumina nanoparticles are present in an amount of at least 99% by weight of catalyst; and
the S_{BET} surface area is from about 17 to about 70 m²/g;
an aliphatic hydrocarbon solvent;
an aliphatic alcohol; and
an interfacial tension reducer.

24. A fluid composition for treating a limestone subterranean hydrocarbon-containing formation, the fluid composition comprising:
a nanocatalyst, said nanocatalyst comprising nickel oxide nanoparticles supported on alumina nanoparticles;
wherein the alumina nanoparticle to nickel oxide nanoparticle weight to weight ratio in the catalyst is in a range of from about 99 to about 400;
wherein the particle size of the alumina nanoparticle is in a range of from about 30 to about 100 nanometers;
wherein the catalyst does not further comprise silver nanoparticles supported on the alumina nanoparticles; and
wherein the alumina nanoparticles are present in an amount of at least 99% by weight of the catalyst or the catalyst S_{BET} surface area is from about 17 to about 70 m²/g;
an aliphatic hydrocarbon solvent;
an aliphatic alcohol; and
an interfacial tension reducer.

25. A method for recovering fluid hydrocarbons from a subterranean limestone formation comprising:
contacting the formation and fluid hydrocarbons contained therein, said formation in fluid communication with a production well;
wherein said contacting of the formation and fluid hydrocarbons contained therein includes contacting with a fluid composition of claim 1 for a time and under conditions sufficient to increase the well's production rate of said fluid hydrocarbons from the formation or to decrease the ratio of water to fluid hydrocarbons in the well's effluent.

26. A method according to claim 6, wherein the fluid composition further comprises a carboxylic acid buffer.

27. A method according to claim 26 wherein the carboxylic acid buffer is acetic acid.

28. A method according to claim 6, wherein the fluid composition further comprises silica.

29. A method according to claim 26, wherein the fluid composition further comprises silica.
